(19) United States
(12) Patent Application Publication
(10) Pub. No.: US 2017/0250465 A1
(43) Pub. Date: Aug. 31, 2017

(54) ANTENNA MODULE

(71) Applicant: AISIN SEIKI KABUSHIKI KAISHA, Kariya-shi (JP)

(72) Inventors: Junichi WAKASUGI, Gifu-ken (JP); Takehiro TABATA, Kariya-shi (JP)

(73) Assignee: AISIN SEIKI KABUSHIKI KAISHA, Kariya-shi (JP)

(21) Appl. No.: 15/380,085

(22) Filed: Dec. 15, 2016

(30) Foreign Application Priority Data
Feb. 29, 2016 (JP) 2016-037344

(51) Int. Cl. H01Q 1/32; H01Q 1/22; H01Q 7/08

(52) U.S. Cl. CPC H01Q 1/3283; H01Q 7/08; H01Q 1/22; H01Q 1/2291; H01Q 1/3241

(57) ABSTRACT

An antenna module which is disposed on an inside of an outside handle of a vehicle door, includes: a magnetic core; a coil into which the magnetic core is inserted; a circuit substrate to which the coil is connected; a base which holds the magnetic core and the circuit substrate; a plurality of conductors of which at least a portion is embedded in the base and which are connected to the circuit substrate; and a sealing portion which seals the coil, in which the base includes a connector portion, a core accommodating portion which accommodates the magnetic core and which is inserted into the coil, and a substrate accommodating portion which accommodates the circuit substrate.

### CROSS REFERENCE TO RELATED APPLICATIONS

This application is based on and claims priority under 35 U.S.C. §119 to Japanese Patent Application 2016-037344, filed on Feb. 29, 2016, the entire contents of which are incorporated herein by reference.

### TECHNICAL FIELD

This disclosure relates to an antenna module which is mounted on an outside handle of a vehicle door.

### BACKGROUND DISCUSSION

As an antenna module built into an outside handle of a vehicle door, a technique described in JP2007-254995A (Reference 1) is known.

The antenna module which is described in the Reference 1 includes an antenna and a substrate to which the antenna is connected. The antenna and the substrate are separately fixed to a case which constitutes the outside handle.

In an antenna module, there is room for improvement in terms of attaching to the outside handle.

### SUMMARY

An antenna module according to an aspect of this disclosure is disposed on an inside of an outside handle of a vehicle door and includes a magnetic core, a coil into which the magnetic core is inserted, a circuit substrate to which the coil is connected, a base which holds the magnetic core and the circuit substrate, a plurality of conductors of which at least a portion is embedded in the base and which are connected to the circuit substrate, and a sealing portion which seals the coil. The base includes a connector portion, a core accommodating portion which accommodates the magnetic core and which is inserted into the coil, and a substrate accommodating portion which accommodates the circuit substrate.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view illustrating an outside handle;

FIG. 2 is a cross-sectional view illustrating the outside handle taken along line II-II of FIG. 1;

FIG. 3 is a perspective view illustrating an antenna module according to a first embodiment;

FIG. 4 is a plan view illustrating the antenna module according to the first embodiment;

FIG. 5 is a cross-sectional view illustrating the antenna module taken along line V-V of FIG. 4;

FIG. 6 is a cross-sectional view illustrating the antenna module taken along line VI-VI of FIG. 4;

FIG. 7 is a perspective view illustrating a set which is configured by a first conductor to a fourth conductor;

FIG. 8 is a perspective view illustrating a primary molded product;

FIG. 9 is a perspective view illustrating the primary molded product on which a magnetic core is mounted;

FIG. 10 is a perspective view illustrating the primary molded product around which an electric wire is wound;

FIG. 11 is a perspective view illustrating the primary molded product on which a circuit substrate is disposed;

FIG. 12 is a perspective view illustrating an antenna module according to a second embodiment;

FIG. 13 is a plan view illustrating the antenna module according to the second embodiment;

FIG. 14 is a cross-sectional view illustrating the antenna module taken along line XIV-XIV of FIG. 13;

FIG. 15 is a cross-sectional view illustrating the antenna module taken along line XV-XV of FIG. 13;

FIG. 16 is a cross-sectional view illustrating the antenna module taken along line XVI-XVI of FIG. 13;

FIG. 17 is a perspective view illustrating a set which is configured by a first conductor to a fourth conductor, and a first electrode and a second electrode;

FIG. 18 is a perspective view illustrating a primary molded product;

FIG. 19 is a perspective view illustrating the primary molded product on which a magnetic core is mounted;

FIG. 20 is a perspective view illustrating the primary molded product around which an electric wire is wound; and

FIG. 21 is a perspective view illustrating the primary molded product on which a circuit substrate is disposed.

### DETAILED DESCRIPTION

An antenna module will be described.

The antenna module is used as an antenna of a wireless device mounted on a vehicle. Preferably, the antenna module has a function of a contact sensor in addition to a function of the antenna. In a first embodiment and a second embodiment to be described below, an example of the antenna module having functions of the antenna and the contact sensor is described.

The wireless device constitutes a portion of an entry system (a system that is capable of locking and unlocking of a vehicle door through wireless communication). The wireless device includes a main body machine, an antenna that transmits and receives a wireless signal, and a portable device that performs wireless communication with the main body machine. For example, the main body machine transmits a request signal through the antenna, receives a response signal (to be described below) of the portable device and detects a position of the portable device based on this reception of the signal. The portable device transmits the response signal when receiving the request signal which is transmitted from the main body machine. A portion of the antenna module functions as the antenna of such a system.

The contact sensor constitutes another element in the entry system. The contact sensor detects whether or not a human body (including a portion of the human body or objects which are carried by or worn on the person, hereinafter, the same) approaches to or is in contact with the outside handle. The entry system controls locking or unlocking of the vehicle door, based on detection of whether or not the human body approaches to or is in contact with the outside handle. A portion of the antenna module functions as the contact sensor of such a system.

### First Embodiment

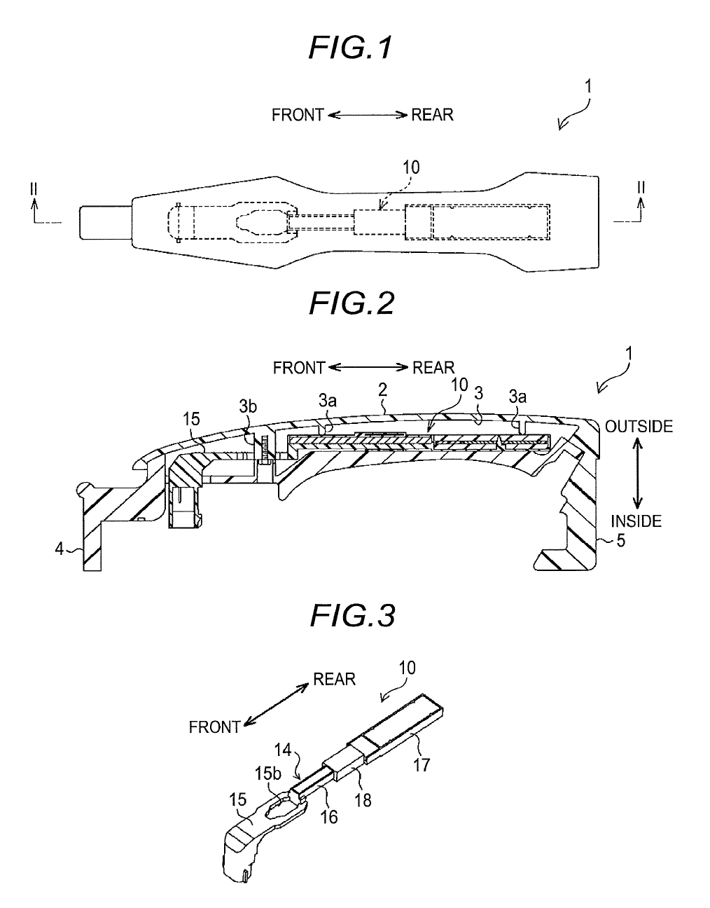

With reference to FIG. 1 to FIG. 11, an example of an antenna module 10 will be illustrated.

A longitudinal direction, a vehicle width direction and a vertical direction of the antenna module 10 are defined based on disposition when the antenna module 10 is mounted on an outside handle 1 of a vehicle door. Specifically, “front side” and “rear side” of the antenna module 10 match a front side and a rear side of a vehicle. “Inside” in the antenna module 10 indicates a direction that faces an inside of the vehicle in the vehicle width direction. “Outside” in the antenna module 10 indicates a direction opposite to the inside. In the antenna module 10, “upper side” indicates an upper side when the antenna module 10 is mounted on the outside handle 1 of the vehicle door. “Lower side” is a side opposite to the upper side.

As illustrated in FIG. 1 and FIG. 2, the antenna module 10 is disposed on the inside of the outside handle 1 of the vehicle door. The outside handle 1 includes a grip portion 2 that includes a module accommodating chamber 3 which accommodates the antenna module 10, a first projection portion 4 that projects from an end portion of the grip portion 2, and a second projection portion 5 that projects from the other end portion of the grip portion 2. The first projection portion 4 is engaged to the vehicle door through a rotating axis. The second projection portion 5 is engaged to a bell crank disposed on the vehicle door side. The bell crank causes a looking mechanism (a mechanism that controls locking of the vehicle door) which is mounted on the vehicle door to be operated by an operation thereof.

A connector portion 15 (see FIG. 2) of the antenna module 10 projects to the vehicle door side, by inserting into an inserting hole which is provided in the outside handle 1. Wiring which extends from a main body machine in the inside of the vehicle door (main body machine of a wireless device) is connected to the connector portion 15 of the antenna module 10.

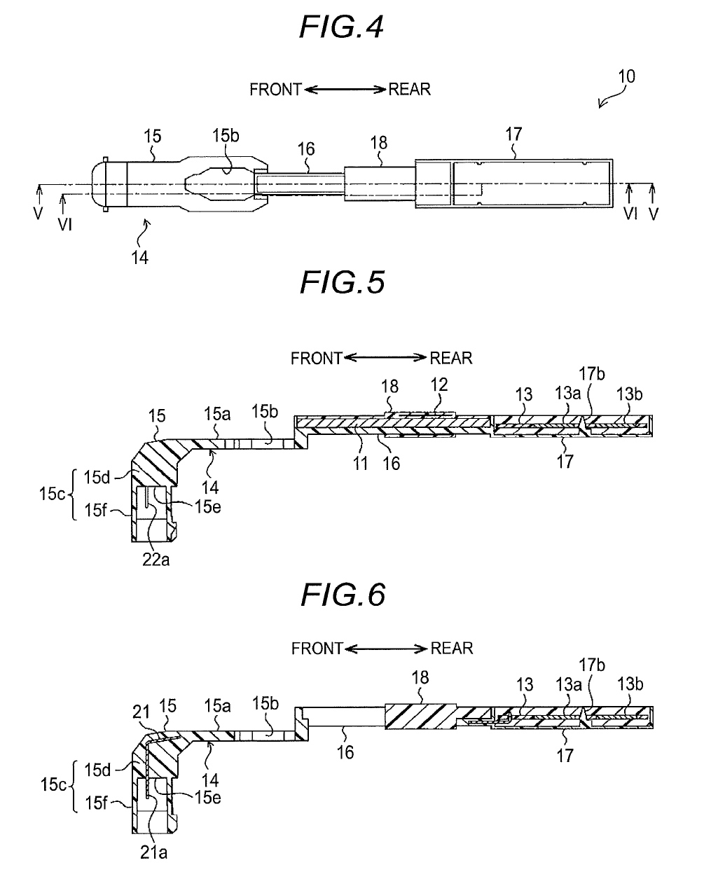

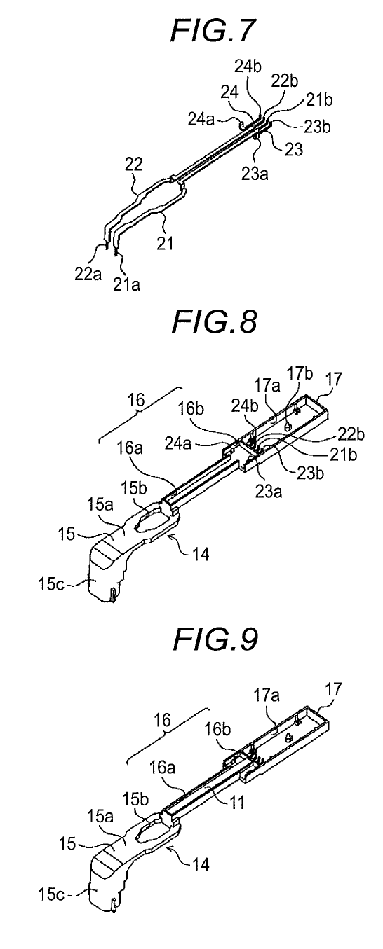

As illustrated in FIG. 3, FIG. 4 and FIG. 5, the antenna module 10 includes a magnetic core 11, a coil 12 into which the magnetic core 11 is inserted, a circuit substrate 13 to which the coil 12 is connected, a base 14, four conductors (hereinafter, referred to as “first conductor 21” to “fourth conductor 24”, respectively, see FIG. 7) and a sealing portion 18 which seals the coil 12.

As illustrated in FIG. 5, the circuit substrate 13 includes a first electrode 13a and a second electrode 13b. The first electrode 13a and the second electrode 13b may be configured to be exposed on both ends in the circuit substrate 13 (see FIG. 5) or may be configured to be exposed from an outside surface (surface which faces the outside).

The first electrode 13a and the second electrode 13b are electrodes for detecting change in electrostatic capacity. The change in electrostatic capacity indicates change in electrostatic capacity of the periphery of the electrode. For example, when a hand is in contact with a portion of the periphery of the first electrode 13a in the outside handle 1, the first electrode 13a is used and thus change in electrostatic capacity is detected since the electrostatic capacity of the periphery of the first electrode 13a is changed. Similarly, when a hand is in contact with a portion of the periphery of the second electrode 13b in the outside handle 1, the second electrode 13b is used and thus change in electrostatic capacity is detected since the electrostatic capacity of the periphery of the second electrode 13b is changed. The first electrode 13a and the second electrode 13b are used in different applications, respectively. For example, the first electrode 13a detects an unlocking operation. The second electrode 13b detects a locking operation. The locking operation indicates an operation of a hand approaching to or being in contact with the outside handle 1 for purpose of locking the vehicle door. The unlocking operation indicates an operation of the hand approaching to or being in contact with the outside handle 1 for purpose of unlocking the vehicle door. A device which detects change in electrostatic capacity using the first electrode 13a and the second electrode 13b is disposed on the circuit substrate 13, on the inside of the vehicle door or on the inside of a control unit in the inside of the vehicle.

The magnetic core 11 is configured in a rod shape and is inserted into the coil 12. The magnetic core 11 is made from a magnetic material such as ferrite, an amorphous magnetic material, for example. The shape of the magnetic core 11 is not limited and for example, has a rectangular parallelepiped shape.

The base 14 holds the magnetic core 11 and the circuit substrate 13.

The base 14 includes a connector portion 15, a core accommodating portion 16 which accommodates the magnetic core 11 and which is inserted into the coil 12, and a substrate accommodating portion 17 which accommodates the circuit substrate 13.

The connector portion 15, the core accommodating portion 16, and the substrate accommodating portion 17 are disposed in an order of the connector portion 15, the core accommodating portion 16, and the substrate accommodating portion 17 in the base 14.

The connector 15 includes an extending portion 15a which extends from the core accommodating portion 16, and a projection portion 15c which projects from the extending portion 15a to the inside in the vehicle width direction (that is, a direction which faces an outer panel side of the vehicle door).

A through hole 15b is provided in the extending portion 15a. The through hole 15b passes through between a first conductor 21 and a second conductor 22 which are described below. When the antenna module 10 is accommodated in the inside of the module accommodating chamber 3 of the outside handle 1, a boss 3b which projects from a wall surface of the module accommodating chamber 3 is inserted into the through hole 15b (see FIG. 2). Accordingly, the antenna module 10 is positioned on the inside of the module accommodating chamber 3.

As illustrated in FIG. 5 and FIG. 6, the projection portion 15c includes a base portion 15d which has an end surface 15e which faces the inside in the vehicle width direction and a peripheral wall 15f which surrounds the periphery of the end surface 15e. An end portion 21a and an end portion 22a (that is, connector terminals) of the first conductor 21 and the second conductor 22 which are described below project from the end surface 15e. The peripheral wall 15f is engaged with a target connector which is connected to the end portion 21a and the end portion 22a of the first conductor 21 and the second conductor 22 and thus holds the target connector.

The core accommodating portion 16 accommodates the magnetic core 11.

The core accommodating portion 16 includes a first concave portion 16a in which a front side portion of the magnetic core 11 is accommodated and a second concave portion 16b in which a rear side portion of the magnetic core 11 is accommodated (see FIG. 8). The first concave portion 16a and the second concave portion 16b communicate with each other and thus constitute a space in which the magnetic core 11 is accommodated. The second concave portion 16b includes a portion on which the magnetic core 11 is disposed, a portion on which a portion of the third conductor 23 is disposed, and a portion on which a portion of the fourth conductor 24 is disposed. Specifically, a width length (width length in the vertical direction) of the second concave portion 16b is greater than the width length of the first concave portion 16a.

An electric wire (specifically, an insulating coating electric wire) is wound spirally around the substrate accommodating portion 17 side in a portion on which the magnetic core 11 is disposed in the core accommodating portion 16. A portion on which the electric wire is wound becomes the coil 12 described above. The magnetic core 11 is inserted into the coil 12.

The substrate accommodating portion 17 accommodates the circuit substrate 13. For example, a concave portion 17a in which the circuit substrate 13 is accommodated is provided in the substrate accommodating portion 17. A direction of an opening of the concave portion 17a is the same as directions of an opening of the first concave portion 16a and an opening of the second concave portion 16b of the core accommodating portion 16 which is described above. A projection 17b which projects from a bottom surface is provided in the concave portion 17a. The projection 17b is inserted into a through hole of the circuit substrate 13 and thus supports the circuit substrate 13.

As illustrated in FIG. 5 to FIG. 8, the first conductor 21 to the fourth conductor 24 are embedded in the base 14 so that a portion thereof is exposed and thus are connected to the circuit substrate 13.

The first conductor 21 and the second conductor 22 are disposed to cover from the connector portion 15 to the substrate accommodating portion 17 and thus are connected to the circuit substrate 13.

Intermediate portions of the first conductor 21 and the second conductor 22 are embedded in the inside of the base 14 and both end portions 21a, 21b, 22a, and 22b of the first conductor 21 and the second conductor 22 are exposed from the base 14. Specifically, the intermediate portions of the first conductor 21 and the second conductor 22 are embedded in the connector portion 15 and the core accommodating portion 16. Both ends 21a and 22a in front sides of the first conductor 21 and the second conductor 22 project from the end surface 15e of the connector portion 15 (see FIG. 5 and FIG. 6) and the end portions 21b and 22b in rear sides of the first conductor 21 and the second conductor 22 project from the bottom surface of the concave portion 17a of the substrate accommodating portion 17 (see FIG. 8).

The third conductor 23 and the fourth conductor 24 are provided to cover from the core accommodating portion 16 to the substrate accommodating portion 17 and thus are connected to the coil 12 and the circuit substrate 13.

Specifically, the intermediate portions of the third conductor 23 and the fourth conductor 24 are embedded in a portion which covers from the core accommodating portion 16 to the substrate accommodating portion 17. The end portions 23a and 24a in front sides of the third conductor 23 and the fourth conductor 24 project from the bottom surface of the second concave portion 16b of the core accommodating portion 16 and end portions 23b and 24b in rear sides of the third conductor 23 and the fourth conductor 24 project from the bottom surface of the concave portion 17a of the substrate accommodating portion 17 (see FIG. 8).

The sealing portion 18 has elasticity. The sealing portion 18 is in contact with the inside surface of the module accommodating chamber 3. Specifically, the sealing portion 18 is configured to be in contact with the contacting portion 3a which is provided in the module accommodating chamber 3. The contacting portion 3a constitutes a portion of the inside surface of the module accommodating chamber 3.

Sealing resin which constitutes the sealing portion 18 fills a gap between the first concave portion 16a of the core accommodating portion 16 and the magnetic core 11 and a gap between the second concave portion 16b of the core accommodating portion 16 and the magnetic core 11. In addition, preferably, the sealing portion 18 seals the coil 12 as well as the circuit substrate 13. For example, the sealing resin which constitutes the sealing portion 18 is filled in the concave portion 17a of the substrate accommodating portion 17 (see FIG. 5 and FIG. 6).

An operation of the antenna module 10 will be described.

In the antenna module 10 as described above, the magnetic core 11, the coil 12 and the circuit substrate 13 are integral with each other through the base 14. According to the structure in the related art, in a case where the outside handle 1 having the antenna function is constituted, there is a need that components are separately mounted on the inside of the outside handle 1. However, according to the configuration described above, there is no need that components are separately mounted on the inside of the outside handle 1. In this way, the antenna module 10 is simply attached to the inside of the outside handle 1.

With reference to FIG. 7 to FIG. 11, a method for producing the antenna module 10 will be illustrated.

In a first step, a set of the first conductor 21, the second conductor 22, the third conductor 23 and the fourth conductor 24 illustrated in FIG. 7 is disposed on a mold. By inserting molding, a primary molded product illustrated in FIG. 8 is formed. By the inserting molding, the connector portion 15, the core accommodating portion 16, and the substrate accommodating portion 17 which are described above are formed.

Next, as illustrated in FIG. 9, the magnetic core 11 is mounted on the core accommodating portion 16.

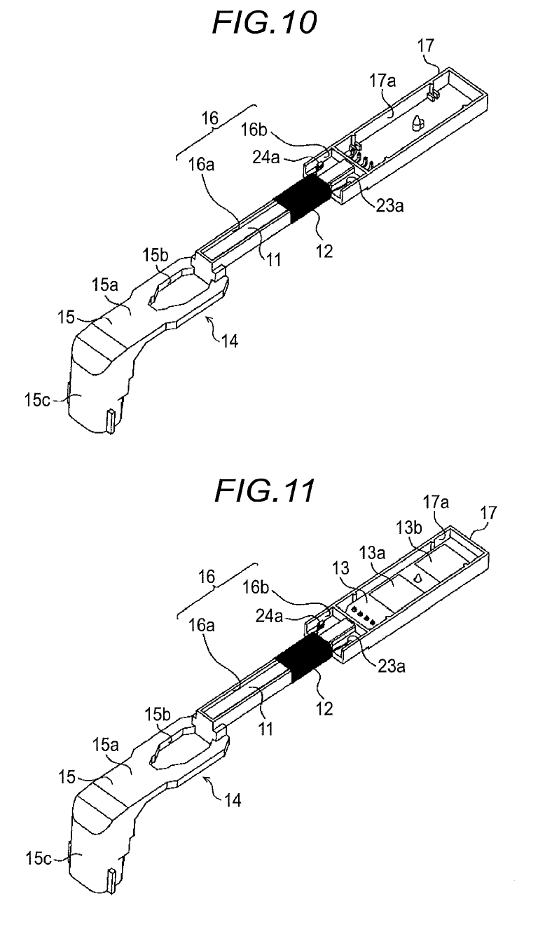

Next, as illustrated in FIG. 10, the coil 12 is formed by the electric wire being wound around the core accommodating portion 16. The end portion of one side of the electric wire is connected to the end portion 23a of the third conductor 23 and the end portion of the other side of the electric wire is connected to the end portion 24a of the fourth conductor 24.

Next, as illustrated in FIG. 11, the circuit substrate 13 is disposed on the substrate accommodating portion 17, the end portions 21b to 24b of the first conductor 21 to the fourth conductor 24 are inserted into four through holes of the circuit substrate 13 and then the through holes and the end portions 21b to 24b of the first conductor 21 to the fourth conductor 24 are connected by welding.

Next, using the sealing resin, the coil 12 and the circuit substrate 13 are sealed. In this way, the antenna module 10 as illustrated in FIG. 3 is formed. As the sealing resin, resin which elastically deforms in the hardened state after molding is used.

Hereinafter, effects of the antenna module 10 will be illustrated.

(1) In the antenna module 10, as described above, the magnetic core 11, the coil 12 and the circuit substrate 13 are integral with each other through the base 14. Therefore, the antenna module 10 is simply attached to the inside of the outside handle 1.

(2) In the antenna module 10, the sealing portion 18 has elasticity and is configured to be in contact with an inside surface of the module accommodating chamber 3 of the outside handle 1. According to the configuration, the antenna module 10 is accommodated in the outside handle 1 in a state where the sealing portion 18 is in contact with the inside surface of the module accommodating chamber 3 and the sealing portion 18 is elastically deformed. Therefore, moving of the antenna module 10 and hitting thereof on the inside surface of the module accommodating chamber 3 due to impact or the like is suppressed. Thus, the generation of abnormal noise is suppressed in the inside of the outside handle 1. In addition, there is no need that an elastic member for fixing the antenna module 10 not to move is provided separately from a sealing member, since the sealing portion 18 provides both a function of sealing the coil 12 and a function of fixing the antenna module 10 not to move.

(3) In the antenna module 10, the core accommodating portion 16 is disposed to be overlapped with a portion of the first conductor 21 and the second conductor 22. According to the configuration, the antenna module 10 becomes compact, unlike in the structure of any one of the first conductor 21 to the fourth conductor 24 is not overlapped with the core accommodating portion 16.

(4) In the antenna module 10, the circuit substrate 13 includes the first electrode 13a and the second electrode 13b for detecting electrostatic capacity. According to the configuration, the antenna module 10 may detect electrostatic capacity. For example, the antenna module 10 may output a voltage change based on change in the electrostatic capacity of the periphery of the first electrode 13a and a voltage change based on change in the electrostatic capacity of the periphery of the second electrode 13b. A device which is connected to the antenna module 10 derives a change in electrostatic capacity, based on these voltage changes and thus detects whether or not the human body approaches to or is in contact with the outside handle 1.

(5) According to the antenna module 10, at the time of the secondary molding, the coil 12 and the circuit substrate 13 are sealed by the sealing resin at the same time. Therefore, producing process becomes simple, unlike in a producing method in which sealing of the coil 12 and sealing of the circuit substrate 13 are separately performed. In addition, a short circuit between the first electrode 13a and the second electrode 13b or a short circuit between the electrodes 13a and 13b and the coil 12 due to attachment of water is suppressed, since the circuit substrate 13 is sealed by the sealing resin. In addition, damage due to electrostatic discharge in the circuit substrate 13 is suppressed by the circuit substrate 13 being sealed by the sealing resin.

### Second Embodiment

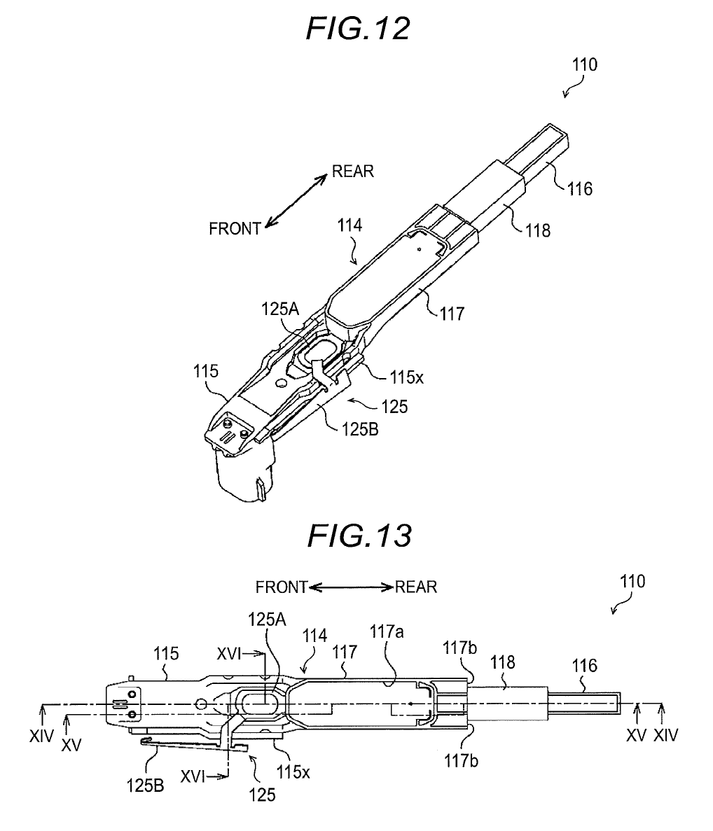

With reference to FIG. 12 to FIG. 21, another example of the antenna module 110 will be illustrated.

As illustrated in FIG. 12 to FIG. 16, the antenna module 110 includes a magnetic core 111, a coil 112 into which the magnetic core 111 is inserted, a circuit substrate 113 to which the coil 112 is connected, a base 114, four conductors (hereinafter, referred to as “first conductor 121” to “fourth conductor 124, respectively), two electrodes (hereinafter, referred to as “first electrode 125” and “second electrode 126’) and a sealing portion 118 which seals the coil 112.

The first electrode 125 and the second electrode 126 are electrodes for detecting change in electrostatic capacity. In other words, the first electrode 125 and the second electrode 126 correspond to the first electrode 13a and the second electrode 13b of the first embodiment and different point between the first electrode 13a and the second electrode 13b of the first embodiment and the first electrode 125 and the second electrode 126 is that the first electrode 125 and the second electrode 126 are provided as a separate component from the circuit substrate 113. The first electrode 125 is used for detecting the locking operation and the second electrode 126 is used for detecting the unlocking operation.

The magnetic core 111 is configured in a rod shape and is inserted into the coil 112. The magnetic core 111 is made from a magnetic material such as ferrite, an amorphous magnetic material, for example. The shape of the magnetic core 111 is not limited and for example, has a rectangular parallelepiped shape.

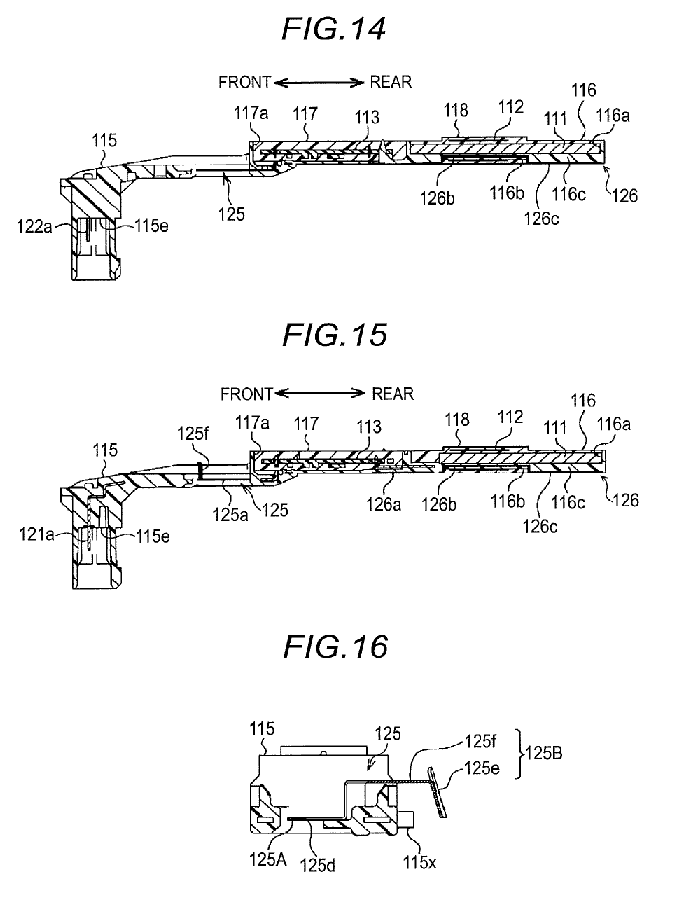

As illustrated in FIG. 14 and FIG. 15, the base 114 holds the magnetic core 111 and the circuit substrate 113.

The base 114 includes a connector portion 115, a core accommodating portion 116 which accommodates the magnetic core 111 and which is inserted into the coil 112, and a substrate accommodating portion 117 which accommodates the circuit substrate 113.

The connector portion 115, the core accommodating portion 116, and the substrate accommodating portion 117 are disposed in an order of the connector portion 115, the substrate accommodating portion 117, and the core accommodating portion 116 in the base 114. In other words, unlike in the first embodiment, the core accommodating portion 116 is disposed on the end side in the antenna module 110.

Structure of the connector portion 115 has the same connector structure portion as the connector portion 15 described in the first embodiment. In addition, the sealing portion 115x is provided in the connector portion 115. The sealing portion 115x has elasticity and is configured by a member which is easily introduced to the gap by pressure. For example, the sealing portion 115x is configured by a rubber porous body having heat resistance and chemical resistance.

The sealing portion 115x is disposed on the vicinity of the side electrode 125B to be described below in the surface of the connector portion 115. Preferably, the sealing portion 115x is disposed on the next position. In other words, when the antenna module 110 is disposed on the inside of the module accommodating chamber 3 of the outside handle 1, the sealing portion 115x is disposed to be positioned in the vicinity of a boundary between an outer case (case of side which is far from the vehicle in the vehicle width direction) and an inner case (case of side which is closer to the vehicle in the vehicle width direction) which constitute the outside handle 1.

The core accommodating portion 116 accommodates the magnetic core 111.

The core accommodating portion 116 includes a concave portion 116a in which the magnetic core 111 is accommodated. The core accommodating portion 116 includes a coil disposition portion 116b and a stepped portion 116c. The stepped portion 116c is provided in the rear side in the portion of the side opposite to the concave portion 116a. When the antenna module 110 is disposed on the module accommodating chamber 3, the stepped portion 116c is disposed closer to the vehicle door side (the inside in the vehicle width direction) than the coil disposition portion 116b. An exposing portion 126c (to be described below) of the second electrode 126 is disposed on the stepped portion 116c. The electric wire is spirally wound around the coil disposition portion 116b in the core accommodating portion 116. A portion on which the electric wire (specifically, an insulating coating electric wire) is wound becomes the coil 112 described above.

The substrate accommodating portion 117 accommodates the circuit substrate 113. For example, a concave portion 117a in which the circuit substrate 113 is accommodated is provided in the substrate accommodating portion 117. A direction of an opening of the concave portion 117a is the same as a direction of the opening of the concave portion 116a of the core accommodating portion 116 which is described above. In addition, the substrate accommodating portion 117 includes a supporting portion 117b which supports the third conductor 123 and the fourth conductor 124 to be described below. The supporting portion 117b extends from the concave portion 117a of the substrate accommodating portion 117 and thus is connected to the side walls (upper wall and lower wall) of the concave portion 116a of the core accommodating portion 116.

The first conductor 121 to the fourth conductor 124 are embedded in the base 114 so that a portion thereof is exposed and thus are connected to the circuit substrate 113.

The first conductor 121 and the second conductor 122 are disposed to cover from the connector portion 115 to the substrate accommodating portion 117 and thus are connected to the circuit substrate 113.

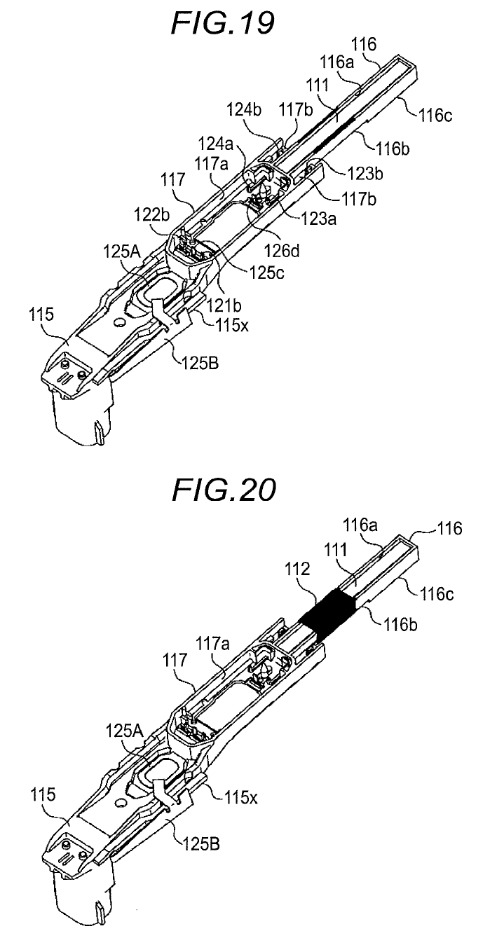

Intermediate portions of the first conductor 121 and the second conductor 122 are embedded in the inside of the base 114 and both end portions 121a, 121b, 122a, and 122b of the first conductor 121 and the second conductor 122 are exposed from the base 114. Specifically, the intermediate portions of the first conductor 121 and the second conductor 122 are embedded in the connector portion 115. Both ends 121a and 122a in front sides of the first conductor 121 and the second conductor 122 project from the end surface 115e of the connector portion 115 and the end portions 121b and 122b in rear sides of the first conductor 121 and the second conductor 122 project from the bottom surface of the concave portion 117a of the substrate accommodating portion 117 (see FIG. 19).

The third conductor 123 and the fourth conductor 124 are connected to the coil 112 and the circuit substrate 113. Specifically, the intermediate portions of the third conductor 123 and the fourth conductor 124 are embedded in the supporting portion 117b of the substrate accommodating portion 117. Ends 123a and 124a in front sides of the third conductor 123 and the fourth conductor 124 project from the concave portion 117a of the substrate accommodating portion 117 and ends 123b and 124b of rear sides of the third conductor 123 and the fourth conductor 124 project from the bottom surface of the supporting portion 117b of the substrate accommodating portion 117.

The first electrode 125 includes a center electrode 125A which is disposed between the first conductor 121 and the second conductor 122. In addition, the first electrode 125 includes a side electrode 125B, in addition to the center electrode 125A, or in place of the center electrode 125A. The side electrode 125B is disposed on the upper surface side or the lower surface side of the outside handle 1, or both surface sides (upper surface side and lower surface side) thereof. The first electrode 125 (FIG. 12) illustrated in the present embodiment includes the center electrode 125A and the side electrode 125B.

The center electrode 125A is disposed between the first conductor 121 and the second conductor 122 (between the first conductor 121 and the second conductor 122 in the vertical direction). A terminal 125c of the first electrode 125 is connected to the circuit substrate 113.

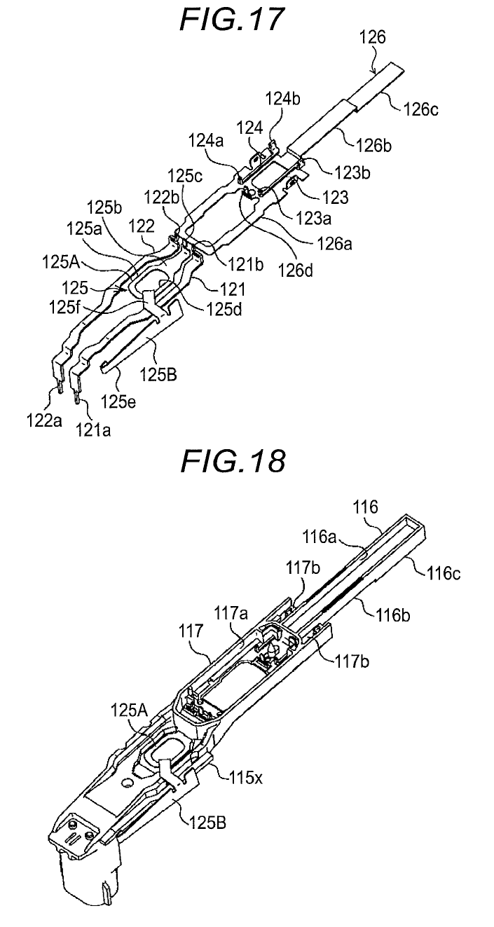

For example, as illustrated in FIG. 17 and FIG. 18, the center electrode 125A includes an exposing portion 125a which is exposed from the base 114, an extending portion 125b which extends from the exposing portion 125a and is embedded in the base 114, and the terminal 125c which is provided in the distal end of the extending portion 125b and then is exposed from the base 114. The terminal 125c is connected to the circuit substrate 113 by welding. In addition, a through hole 125d is provided in the exposing portion 125a of the center electrode 125A. A boss (corresponding to the boss 3b described in the first embodiment) which is provided in the inside of the module accommodating chamber 3 is inserted into the through hole 125d.

The side electrode 125B includes a side surface portion 125e which is disposed on the side of the connector portion 115 and a connecting portion 125f which connects the exposing portion 125a of the center electrode 125A and the side surface portion 125e (see FIG. 17).

The second electrode 126 is disposed to cover the core accommodating portion 116 and the substrate accommodating portion 117 in the base 114.

For example, as illustrated in FIG. 14, FIG. 15, FIG. 17 and FIG. 18, the second electrode 126 includes an main body portion 126a which is embedded in the substrate accommodating portion 117 in the base 114, an extending portion 126b which extends from the main body portion 126a and then is embedded in the core accommodating portion 116, and an exposing portion 126c which extends from the extending portion 126b and then is exposed from the core accommodating portion 116. The exposing portion 126c is disposed on the stepped portion 116c of the side opposite to the concave portion 116a of the core accommodating portion 116. The exposing portion 126c is disposed to be closer to the vehicle door side (the inside in the vehicle width direction) than the extending portion 126b. Accordingly, increase in sensitivity of the second electrode 126 (increase in change width of electrostatic capacity) is achieved.

The coil 112 described above is disposed not to be overlapped with the exposing portion 126c. A terminal 126d which projects from the bottom surface of the substrate accommodating portion 117 is provided in the main body portion 126a. The terminal 126d is connected to the circuit substrate 113 by welding.

The sealing portion 118 has elasticity. The sealing portion 118 is in contact with the inside surface of the module accommodating chamber 3. Specifically, the sealing portion 118 is configured to be in contact with the contacting portion 3a which is provided in the module accommodating chamber 3.

Sealing resin which constitutes the sealing portion 118 fills a gap between the concave portion 116a of the core accommodating portion 116 and the magnetic core 111. In addition, preferably, the sealing portion 118 seals the coil 112 as well as the circuit substrate 113. For example, the sealing resin which constitutes the sealing portion 118 is filled in the concave portion 117a of the substrate accommodating portion 117.

With reference to FIG. 17 to FIG. 21, a method for producing the antenna module 110 will be illustrated.

In a first step, a set of the first conductor 121, the second conductor 122, the third conductor 123 and the fourth conductor 124 illustrated in FIG. 17 is disposed on a mold. By inserting molding, a primary molded product illustrated in FIG. 18 is formed. By the inserting molding, the connector portion 115, the core accommodating portion 116, and the substrate accommodating portion 117 described above is formed. Further, the sealing member for constituting the sealing portion 115x is attached to the connector portion 115 by adhesive or heat bonding.

Next, as illustrated in FIG. 19, the magnetic core 111 is mounted on the core accommodating portion 116.

Next, as illustrated in FIG. 20, the coil 112 is formed by the electric wire being wound around the core accommodating portion 116. The end portion of the one side of the electric wire is connected to the end portion 123a of the third conductor 123 and the end portion of the other side of the electric wire is connected to the end portion 124a of the fourth conductor 124.

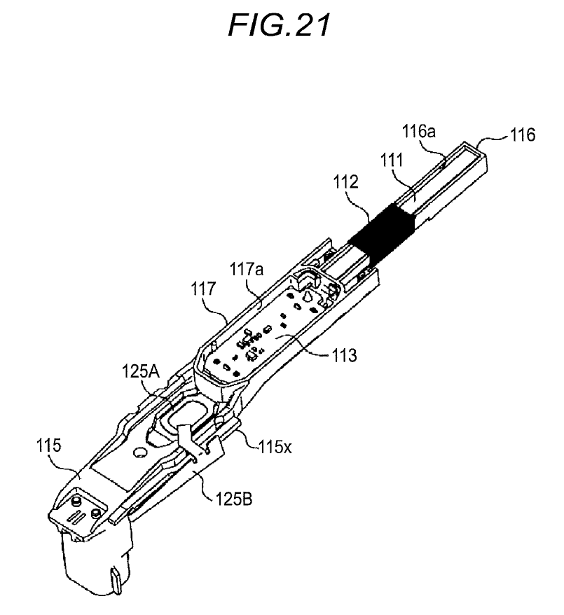

Next, as illustrated in FIG. 21, the circuit substrate 113 is disposed on the substrate accommodating portion 117, the end portions 121b, 122b, 123a, and 124a of the first conductor 121 to the fourth conductor 124 and the terminals 125c and 126d of the first electrode 125 and the second electrode 126 are inserted into six through holes of the circuit substrate 113, respectively and then the through holes, the end portions 121b, 122b, 123a, and 124a of the first conductor 121 to the fourth conductor 124 and the terminals 125c and 126d of the first electrode 125 and the second electrode 126 are connected by welding.

Next, using the sealing resin having elasticity after hardened, the coil 112 and the circuit substrate 113 are sealed. In this way, the antenna module 110 as illustrated in FIG. 12 is formed.

Hereinafter, effects of the antenna module 110 will be illustrated.

(1) In the antenna module 110, the magnetic core 111, the coil 112, and the circuit substrate 113 are integral with each other through the base 114, similar to the antenna module 10 according to the first embodiment. Therefore, the antenna module 110 is simply attached to the inside of the outside handle 1.

(2) The antenna module 110 includes the first electrode 125 and the second electrode 126. The second electrode 126 includes a main body portion 126a which is embedded in an inside of the substrate accommodating portion 117, an exposing portion 126c which extends from the main body portion 126a to the core accommodating portion 116 and thus is exposed, and a terminal 126d which is connected to the circuit substrate 113 by extending from the main body portion 126a. According to the configuration, the substrate accommodating portion 117 is reinforced by the main body portion 126a of the second electrode 126. Therefore, deformation of the base 114 is suppressed.

(3) The first electrode 125 includes the center electrode 125A and the side electrode 125B. The center electrode 125A faces the outside in the vehicle width direction and the side electrode 125B faces a direction which is different from the direction of the center electrode 125A. According to the configuration, detection of objects (for example, human body) in the portion which faces the center electrode 125A and detection of objects (for example, human body) in the portion which faces the side electrode 125B can be performed. In other words, whether or not objects (for example, human body) approach to or are in contact with the outside handle 1 from the two directions can be detected.

(4) In the antenna module 110, the sealing portion 115x is disposed on the vicinity of the side electrode 125B in the base 114. According to the configuration, penetration of water to the side electrode 125B can be suppressed, since the vicinity of the side electrode 125B is sealed. In particular, when the sealing portion 115x is disposed on the boundary between the outside case and the inner case which constitutes the outside handle 1, corrosion of the side electrode 125B is effectively suppressed, since intrusion of water that water is penetrated through this boundary is blocked by the side electrode 125B. In addition, short circuit between a vehicle door sheet metal and the side electrode 125B is prevented and thus degradation of sensor performance is suppressed.

### Another Embodiment

An electrode which corresponds to the side electrode 125B which is described in the second embodiment can be provided in the first embodiment. For example, the electrode which corresponds to the side electrode 125B is connected to the circuit substrate 13 and is connected to the first electrode 13a or the second electrode 13b by the wiring of the inside of the circuit substrate 13 in the first embodiment.

In the first embodiment and in the second embodiment, although the coils 12 and 112 are connected to the circuit substrates 13 and 113 through the third conductors 23 and 123 and the fourth conductors 24 and 124, the end portions of the coils 12, 112 can be connected to the circuit substrates 13 and 113 not through the conductor but directly.

In the first embodiment and in the second embodiment, although the coils 12 and 112 are configured by one coil element, the coils 12 and 112 may be configured by a plurality of sub-coil elements which are connected in series. As described in the second embodiment, the detection sensitivity of electrostatic capacity can be changed in the longitudinal direction of the electrode, by the electrode being inserted into the coil element. For, example, a low sensitivity area and a high sensitivity area along the longitudinal direction can be provided in the electrode having a determined size (for example, size which is longer than the back of the hand), by disposing the plurality of sub-coil elements. Accordingly, the operation (the pattern of the speed and the operation) of the human body (for example, hand) which moves along the longitudinal direction of the electrode can be detected.

In the antenna modules 10 and 110 which are described in the first embodiment and the second embodiment, the number of the electrodes for detecting electrostatic capacity is not limited. The number of the electrodes is determined according to the object and the performance thereof.

(1) An antenna module according to an aspect of this disclosure is disposed on an inside of an outside handle of a vehicle door and includes a magnetic core, a coil into which the magnetic core is inserted, a circuit substrate to which the coil is connected, a base which holds the magnetic core and the circuit substrate, a plurality of conductors of which at least a portion is embedded in the base and which are connected to the circuit substrate, and a sealing portion which seals the coil. The base includes a connector portion, a core accommodating portion which accommodates the magnetic core and which is inserted into the coil, and a substrate accommodating portion which accommodates the circuit substrate.

According to the configuration, there is no need to mount the individual component on the inside of the outside handle since the magnetic core, the coil and the circuit substrate become integral with each other through the base. Therefore, according to the configuration, the antenna module can be simply attached to the inside of the outside handle.

(2) The antenna module may be configured such that the sealing portion has elasticity and is configured to be in contact with an inside surface of a module accommodating chamber in which the antenna module is accommodated in the outside handle.

According to this configuration, the antenna module is accommodated in the outside handle in a state where the sealing portion is in contact with the inside surface of the module accommodating chamber and the sealing portion is elastically deformed. Therefore, moving of the antenna module and hitting thereof on the inside surface of the module accommodating chamber due to impact or the like is suppressed.

(3) The antenna module may be configured such that at least a portion of the core accommodating portion is disposed to be overlapped with at least one of the plurality of conductors.

According to this configuration, the antenna module becomes compact, unlike in the structure of any conductor is not overlapped with the core accommodating portion.

(4) The antenna module may be configured such that the connector portion, the core accommodating portion, and the substrate accommodating portion are disposed in an order of the connector portion, the core accommodating portion, and the substrate accommodating portion in the base, and the plurality of conductors include a first conductor and a second conductor and the first conductor and the second conductor are disposed to cover from the connector portion to the substrate accommodating portion and thus are connected to the circuit substrate. This configuration is an example of the antenna module in which the connector portion, the magnetic core, and the circuit substrate are disposed in this order in the base.

(5) The antenna module may be configured such that the circuit substrate includes an electrode for detecting electrostatic capacity.

According to this configuration, the antenna module may detect electrostatic capacity.

(6) The antenna module may be configured such that the connector portion, the core accommodating portion, and the substrate accommodating portion are disposed in an order of the connector portion, the substrate accommodating portion, and the core accommodating portion in the base, and a first conductor and a second conductor as the plurality of conductors and a first electrode and a second electrode for detecting electrostatic capacity are included, and the first conductor and the second conductor are disposed to cover from the connector portion to the substrate accommodating portion and thus are connected to the circuit substrate. This configuration is a configuration in which the connector portion, the circuit substrate, the magnetic core are disposed in this order in the base and is an example of the antenna module in which two electrodes are included.

(7) The antenna module may be configured such that the second electrode includes a main body portion which is embedded in an inside of the substrate accommodating portion, an exposing portion which extends from the main body portion to the core accommodating portion and thus is exposed, and a terminal which is connected to the circuit substrate by extending from the main body portion. According to this configuration, the substrate accommodating portion is reinforced by the main body portion of the second electrode.

(8) The antenna module may be configured such that the first electrode includes a center electrode and a side electrode and the center electrode faces an outside in a vehicle width direction when the antenna module is accommodated to the outside handle and the side electrode faces a direction which is different from the direction of the center electrode. According to the configuration, whether or not objects approach to or are in contact with the outside handle from the two directions can be detected.

(9) The antenna module may be configured such that the sealing portion is disposed on the vicinity of the side electrode in the base.

According to this configuration, penetration of water to the side electrode can be suppressed, since the periphery of the side electrode is sealed.

The antenna module has a simple structure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An antenna module which is disposed on an inside of an outside handle of a vehicle door, comprising:
a magnetic core;
a coil into which the magnetic core is inserted;
a circuit substrate to which the coil is connected;
a base which holds the magnetic core and the circuit substrate;
a plurality of conductors of which at least a portion is embedded in the base and which are connected to the circuit substrate; and
a sealing portion which seals the coil,
wherein the base includes a connector portion, a core accommodating portion which accommodates the magnetic core and which is inserted into the coil, and a substrate accommodating portion which accommodates the circuit substrate.

2. The antenna module according to claim 1,
wherein the sealing portion has elasticity and is configured to be in contact with an inside surface of a module accommodating chamber in which the antenna module is accommodated in the outside handle.

3. The antenna module according to claim 1,
wherein at least a portion of the core accommodating portion is disposed to be overlapped with at least one of the plurality of conductors.

4. The antenna module according to claim 1,
wherein the connector portion, the core accommodating portion, and the substrate accommodating portion are disposed in an order of the connector portion, the core accommodating portion, and the substrate accommodating portion in the base,
the plurality of conductors include a first conductor and a second conductor, and
the first conductor and the second conductor are disposed to cover from the connector portion to the substrate accommodating portion and thus are connected to the circuit substrate.

5. The antenna module according to claim 4,
wherein the circuit substrate includes an electrode for detecting electrostatic capacity.

6. The antenna module according to claim 1,
wherein the connector portion, the core accommodating portion, and the substrate accommodating portion are disposed in an order of the connector portion, the substrate accommodating portion, and the core accommodating portion in the base,
a first conductor and a second conductor as the plurality of conductors, and a first electrode and a second electrode for detecting electrostatic capacity are included, and
the first conductor and the second conductor are disposed to cover from the connector portion to the substrate accommodating portion and thus are connected to the circuit substrate.

7. The antenna module according to claim 6,
wherein the second electrode includes a main body portion which is embedded in an inside of the substrate accommodating portion, an exposing portion which extends from the main body portion to the core accommodating portion and thus is exposed, and a terminal which is connected to the circuit substrate by extending from the main body portion.

8. The antenna module according to claim 6,
wherein the first electrode includes a center electrode and a side electrode, and
the center electrode faces an outside in a vehicle width direction when the antenna module is accommodated in the outside handle and the side electrode faces a direction which is different from the direction of the center electrode.

9. The antenna module according to claim 8,
wherein the sealing portion is disposed on the vicinity of the side electrode in the base.
